(19) United States
(12) Patent Application Publication
(10) Pub. No.: US 2006/0279009 A1
(43) Pub. Date: Dec. 14, 2006

(54) Heat and air conditioning deodorant appliance

(76) Inventors: Greg Hall, Arlington, TX (US); Minnie Hall, Arlington, TX (US); Robert R. Todd, Viera, FL (US); Clois J. Todd, Viera, FL (US)

Correspondence Address: Ralph Gregory Hall, 1603 Crest Meadow Lane, Mansfield, TX, 76063, US

(21) Appl. No.: 11/090,994

(22) Filed: Mar. 28, 2005

(51) Int. Cl. B01F 3/04

(52) U.S. Cl. 261/116; 261/DIG. 88; 261/26

(57) ABSTRACT

A device injecting a deodorant through an atomizing nozzle into the “output” duct of a home Heat and Air Conditioning System. The device may be used in other areas such as small businesses and may be used to inject disinfectant.

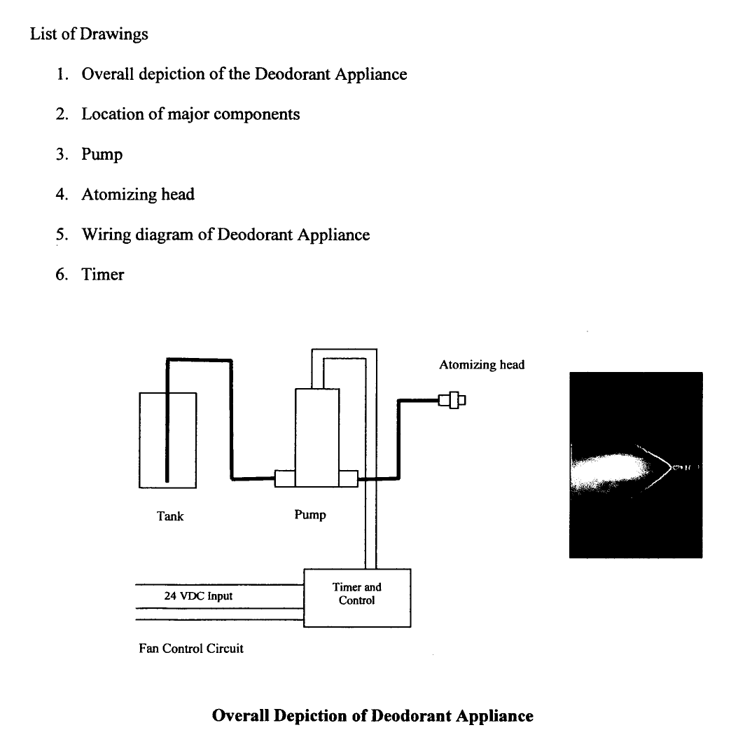

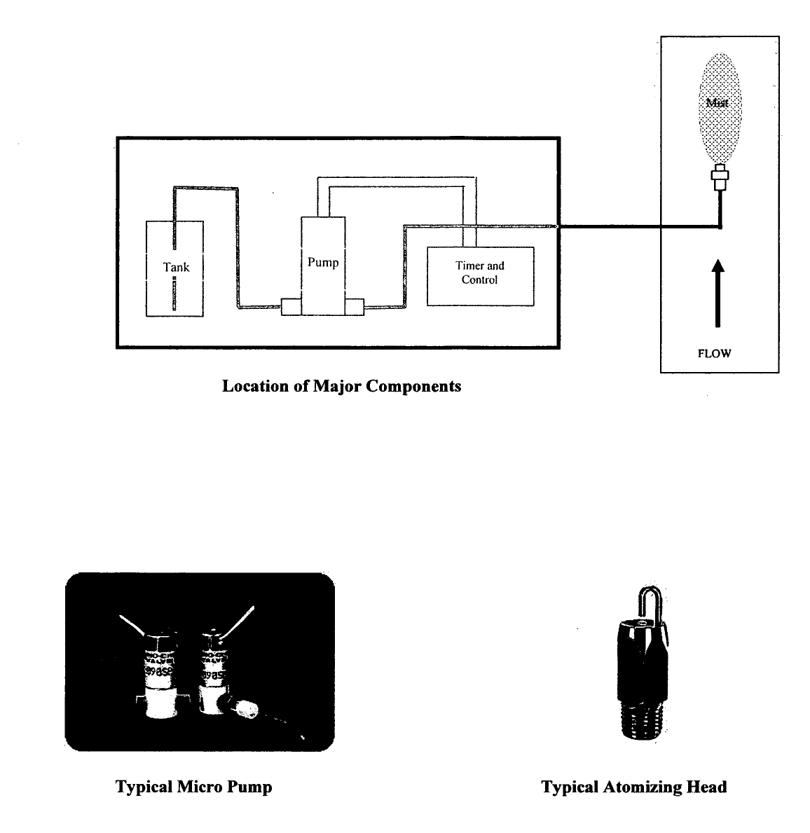

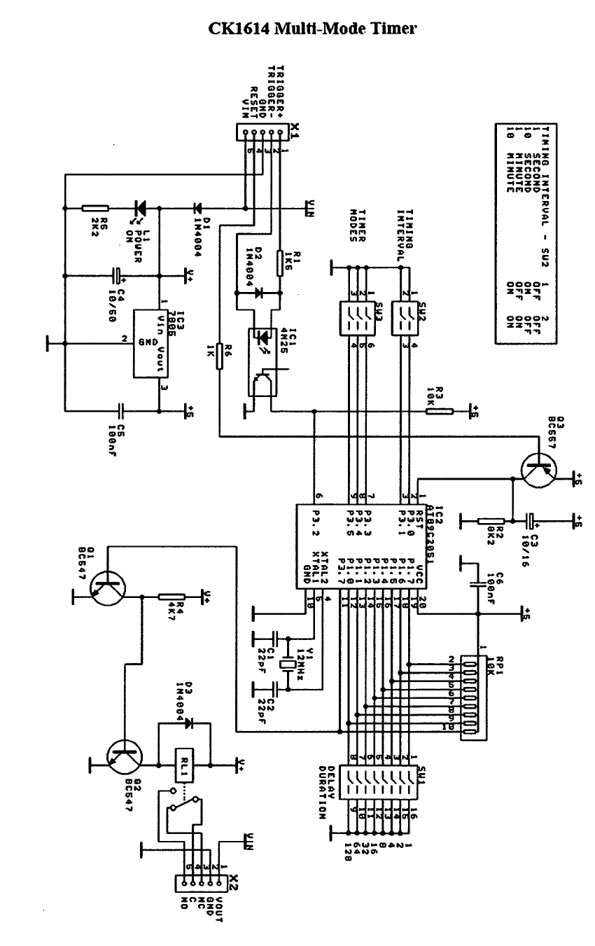

This application claims priority under 35 U.S.C.sctn. 119 based on U.S. Provisional Application No. 11/090,994, filed Mar. 28, 2005, the disclosure of which is incorporated herein by reference.

The Deodorant Appliance is used with Central Heating and Air Systems to improve the quality of the air.

The appliance will eliminate the use of room to room deodorizing.

Function of Application:

1. function with central air conditioning systems.
2. introduces deodorant in large areas occupied by individuals.
3. introduces disinfects in large areas occupied by individuals.

The appliance consists of the following:
1. A small reservoir to hold the deodorant
2. A sight glass on the reservoir will indicate deodorant level
3. A small self-priming pump to move the deodorant from the reservoir
4. An atomizing spray head for deodorant injection
5. An appropriate length of tubing to connect reservoir to the atomizing head.
6. An electronic circuit to determine the injection intervals and pre-set times.
7. An appropriate length of wire to connect the thermostat to the appliance

Operational Description:

The appliance requires two parameters to operate:

Parameter 1—heating and air conditioning system fan must be running. This parameter signal will be tapped off the fan control circuit.

Parameter 2—appliance ‘CK 1614 Multi-Mode Timer’ must be set to pre-set times. The timer has 8 timer modes and a wide timing range. (See Specifications) The mode and the timing range will be selected when strength of deodorant utilized is determined.

| SPECIFICATIONS | |
|---|---|
| Operating Voltage | 12 VDC (see text) |
| Trigger Voltage | 6-81 V (see text) |
| Trigger Current | 5 mA minimum (see text) |
| | 80 mA maximum |
| Trigger Voltage Isolation | 2500 V |
| Trigger Pulse Width | 20 mS minimum |
| Relay Contact Rating | 10 A/240 V AC/DC max. |
| Timing Modes | 8 (see text) |
| Timing Ranges | 1-255 seconds |
| | 10-2550 seconds |
| | 1-255 minutes |
| | 10-2550 minutes |

Mode 1—Instant On, Delayed Off, Level triggered
Mode 2—Instant On, Delayed Off, Edge triggered
Mode 3—Delayed On

Trigger signal starts the timing cycle. At the end of the delay time the relay operates and stays operated until the trigger signal is removed or the timer is reset. Loss of trigger signal during the delay time aborts the timing cycle.

Mode 4—Instant On and Hold

Mode 5—Toggling

Mode 6—Instant On, Delayed Off,

Mode 7—Delayed ON with Pause

When the two parameters have been met, the appliance pump will supply a short puff of deodorant to the atomizing head then in turn will spray it into the exhaust plenum of the heating and air conditioning system. The amount of deodorant sprayed at any given time will be set by the installing technician.

Installation Requirements:

The Deodorant Appliance is a self contained unit that can be installed on the heating and air conditioning system, the wall next to the heating and air-conditioning system. Electrical connections can be made at the heating and air-conditioning system control panel.

1. A method for misting substance into the air in all of the areas of a dwelling serviced by a central heating and air conditioning system.

2. The method of claim 1, wherein the substance includes deodorants or disinfectants.

3. The method of claim 1, whereas the dwelling consists of homes, offices, retail outs, and other habitable areas served by a central heating and air conditioning system.
